(19) United States
(12) Patent Application Publication
(10) Pub. No.: US 2011/0063360 A1
(43) Pub. Date: Mar. 17, 2011

(54) Inkjet print head and method of measuring temperature thereof

(75) Inventors: Suk Ho Song, Ansan (KR); Jae Woo Joung, Suwon (KR); Yoon Sok Park, Suwon (KR)

(73) Assignee: SAMSUNG ELECTRO-MECHANICS CO., LTD., Suwon (KR)

(21) Appl. No.: 12/654,426

(22) Filed: Dec. 18, 2009

(30) Foreign Application Priority Data
Sep. 16, 2009 (KR) 10-2009-0087727

(51) Int. Cl. B41J 29/393

(52) U.S. Cl. 347/19

(57) ABSTRACT

An inkjet print head includes a plurality of pressure chambers receiving and storing ink which is to be discharged to a nozzle, a piezoelectric body interposing a membrane with the pressure chamber, the piezoelectric body providing a driving force for discharging ink to each of the pressure chambers, and a measuring unit measuring capacitance of the piezoelectric body so that a temperature of ink being discharged to the nozzle is measured.

### CROSS-REFERENCE TO RELATED APPLICATIONS

This application claims the priority of Korean Patent Application No. 10-2009-0087727 filed on Sep. 16, 2009, the Korean Intellectual Property Office, the disclosure of which is incorporated herein by reference.

### BACKGROUND OF THE INVENTION

1. Field of the Invention

The present invention relates to an inkjet print head and a method of measuring a temperature thereof, and more particularly, to an inkjet print head capable of measuring a temperature by using a capacitance change of a piezoelectric body, and a method of measuring a temperature thereof.

2. Description of the Related Art

In general, an inkjet head is a structure that ejects ink droplets through a nozzle by converting an electrical signal into a physical force. Notably, an inkjet head assembly includes an inkjet head having a nozzle plate and a cartridge supplying ink to the inkjet head.

Of late, a piezoelectric inkjet head has been applied to industrial inkjet printers. The piezoelectric inkjet head may be used to directly form circuit patterns on a printed circuit board (PCB) by ejecting ink obtained by melting metal such as gold or silver, or to manufacture liquid crystal displays (LCD) or organic light emitting diodes (OLED). Furthermore, the piezoelectric inkjet head may be used for industrial graphic designs, or solar cells.

An inkjet head of an industrial inkjet printer includes an inlet and an outlet through which ink flows in and out from a cartridge, a reservoir storing ink provided from the cartridge, and a chamber transmitting a driving force of an actuator in order to transfer ink from the reservoir to a nozzle.

While an existing OA digital printer discharges ink at a normal temperature, an industrial inkjet printer discharges ink at a temperature of 80° C. or higher in most cases in order to overcome high viscosity.

Therefore, the use of ink being discharged at a high temperature necessitates technologies that accurately monitor the temperature of an inkjet head portion in real time.

According to the related art, to measure a temperature of an inkjet print head, a thermocouple is attached to a reservoir or the like in the inkjet head print, and measures an ink temperature in the reservoir. This measured ink temperature is assumed to be the same as the head temperature, so that the head temperature can be measured in an indirect way.

As an improved version of the above related art, a thermocouple may be attached directly to a head nozzle surface, or laser thermometers may be used to indirectly measure the temperature from the outside.

However, when a thermocouple is attached directly onto the head nozzle surface, a printing medium contacts the thermocouple during a printing operation, thereby impairing printing performance.

Furthermore, when a laser thermometer is used to measure the head temperature, a roughened nozzle surface reflects lasers. This obstructs measuring and real-time monitoring.

### SUMMARY OF THE INVENTION

An aspect of the present invention provides an inkjet print head, capable of measuring a temperature by using a capacitance change in a piezoelectric body, and a method of measuring a temperature thereof.

According to an aspect of the present invention, there is provided an inkjet print head including: a plurality of pressure chambers receiving and storing ink which is to be discharged to a nozzle; a piezoelectric body interposing a membrane with the pressure chamber, the piezoelectric body providing a driving force for discharging ink to each of the pressure chambers; and a measuring unit measuring capacitance of the piezoelectric body so that a temperature of ink being discharged to the nozzle is measured.

The inkjet print head may further include: an idle pressure chamber configured to control a pressure of the ink being discharged, the idle pressure chamber not performing an ink discharge operation; and an idle piezoelectric body interposing a membrane with the idle pressure chamber.

The inkjet print head may further include a measuring unit measuring capacitance of the idle piezoelectric body.

According to another aspect of the present invention, there is provided an inkjet print head including: a plurality of pressure chambers receiving and storing ink which is to be discharged to a nozzle; a piezoelectric body interposing a membrane with the pressure chamber, the piezoelectric body providing a driving force for discharging ink to each of the pressure chambers; an idle pressure chamber disposed outside the pressure chamber in a width direction to control a pressure of the ink being discharged, the idle pressure chamber not performing an ink discharge operation; an idle piezoelectric body interposing a membrane with the idle pressure chamber; and a measuring unit measuring capacitance of the idle piezoelectric body so that a temperature of the ink being discharged to the nozzle is measured.

According to another aspect of the present invention, there is provided a method of measuring a temperature of an inkjet print head, the method including: setting an initial capacitance value by measuring capacitance of a piezoelectric body or an idle piezoelectric body at an initial temperature; while varying a temperature, measuring capacitance of the piezoelectric body or the idle piezoelectric body at each varied temperature, and obtaining a difference value between the initial capacitance value and the measured capacitance to set a capacitance change rate; and measuring a temperature, which is to be measured, by measuring capacitance of the piezoelectric body or the idle piezoelectric body and comparing a capacitance change rate of the measured capacitance with the set capacitance change rate.

The initial temperature may be set between 20° C. and 80° C., and the temperature may be varied at constant intervals.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view illustrating an inkjet head assembly according to an exemplary embodiment of the present invention;

FIG. 2 is a schematic cross-sectional view taken along the line II-II of FIG. 1, illustrating the inkjet print head;

FIG. 3 is a schematic cross-sectional view taken along the line III-III of FIG. 1, illustrating the inkjet print head; and

FIG. 4 is a graph illustrating relations among temperature, capacitance and change rates for illustrating a method of measuring a temperature of an inkjet print head according to an exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. While those skilled in the art could readily devise many other varied embodiments that incorporate the teachings of the present invention through the addition, modification or deletion of elements, such embodiments may fall within the scope of the present invention.

In the drawings, like reference numerals in the drawings denote like elements.

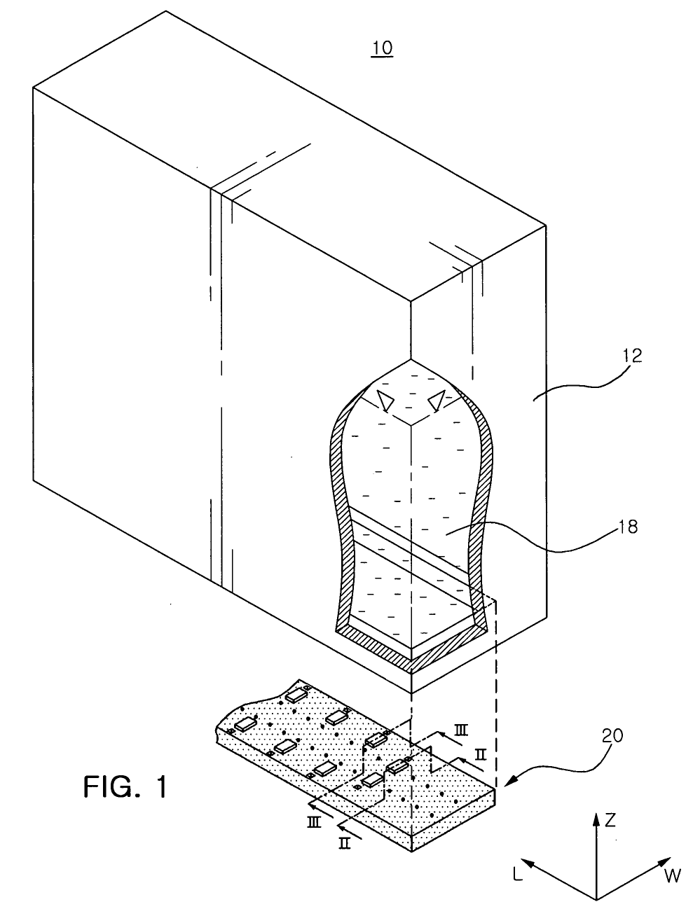

FIG. 1 is a perspective view illustrating an inkjet head assembly according to an exemplary embodiment of the present invention.

Referring to FIG. 1, an inkjet head assembly 10, according to an exemplary embodiment of the present invention, includes an inkjet print head 20, and an ink cartridge 12 supplying ink 18 to the inkjet print head 20.

The inkjet print head 20 is received in the ink cartridge 12 having a rectangular parallelepiped shape. The inkjet print head 20 is a stack of silicon plates, which receives the ink 18 from the ink cartridge 12 and discharges it onto an external printing medium.

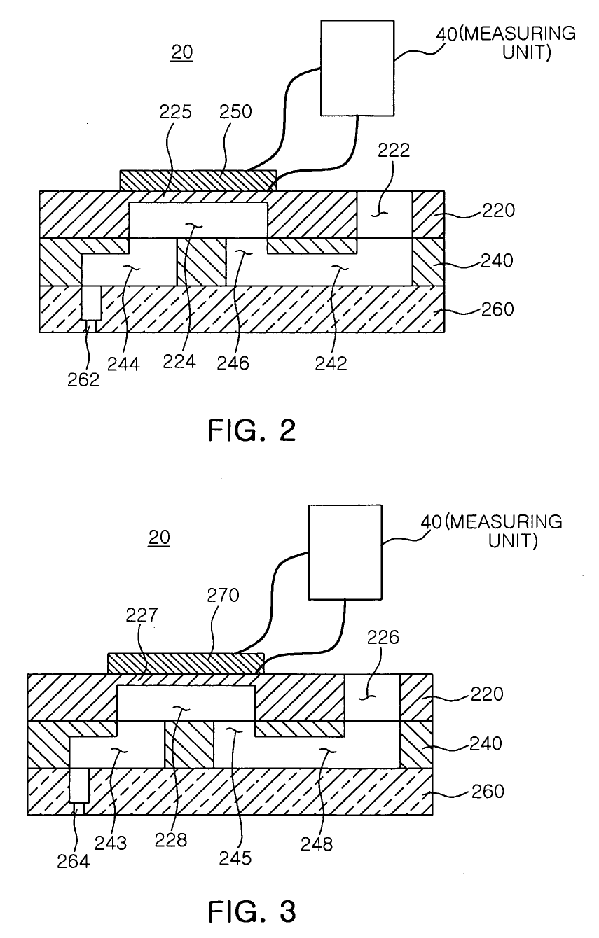

As shown in FIG. 2, the inkjet print head 20 may be formed by stacking a plurality of substrates having holes serving as an ink passage.

FIG. 2 is a schematic cross-sectional view taken along line the II-II of FIG. 1, illustrating the inkjet print head.

Referring to FIG. 2, the inkjet print head 20, according to this embodiment, may include a plurality of pressure chambers 224, a piezoelectric body 250, and a measuring unit 40 measuring the capacitance of the piezoelectric body 250.

Here, the inkjet print head 20 is formed by stacking a lower substrate 260, an intermediate substrate 240 and an upper substrate 220 sequentially in a direction toward the side of the inkjet print head 20 contacting the ink cartridge 12 with reference to FIG. 2.

Directions used in the following descriptions will now be defined. First, a direction from the lower substrate 260 toward the upper substrate 220 is defined as a stacked direction (Z), a direction in which the piezoelectric body 250 is arranged along the line II-II on the inkjet print head 20 is defined as a width direction (W), and a direction in which a nozzle 262 is arranged vertically in the inkjet head 20 is defined as a length direction (L).

The upper substrate 220 includes an ink inlet 222 through which ink flows into the inkjet head 20, and a pressure chamber 224 providing a discharge driving force to the ink. The piezoelectric body 250 may be provided on the pressure chamber 224 while a membrane 225 is interposed therebetween. The piezoelectric body 250 provides a driving force for ink discharge to the pressure chamber 224.

The piezoelectric body 250 may serve to discharge ink by deforming the membrane 225, which is the top surface of the pressure chamber 224. The piezoelectric body is an element that can convert electrical energy into mechanical energy or vice versa. A representative material of the piezoelectric body 250 is Pb (Zr, Ti) O₃. Alternatively, for the ink discharge, a bubble jet or thermal jet method may be used instead of the piezoelectric method using the piezoelectric body 250.

The lower substrate 260 includes the nozzle 262, and the intermediate substrate 240 may include a damper 244 and a reservoir 242 storing ink within the head. In addition, the intermediate substrate 240 may include a restrictor 246 to prevent ink within the pressure chamber 224 from flowing backward to the reservoir 242.

The piezoelectric body 250 is configured by forming upper and lower electrodes on the top and bottom surfaces of a piezoelectric material layer deformed by power supply. To supply voltage, a flexible printed circuit board may be connected to these upper and lower electrodes.

The measuring unit 40 may measure the capacitance of the piezoelectric body 250 from the upper and lower electrodes so that the temperature of the ink within the inkjet print head 20 is measured.

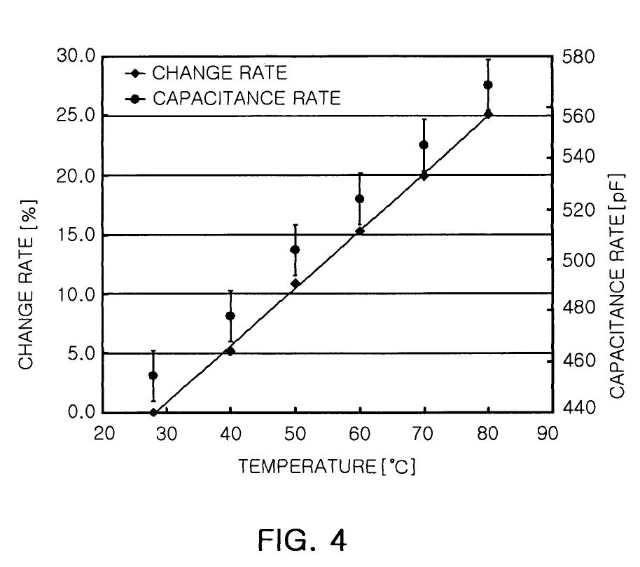

Since the capacitance of the piezoelectric body 250 is in linear relation with the temperature as shown in FIG. 4, measuring the capacitance of the piezoelectric body 250 may lead to temperature estimation.

In order to control the pressure of ink being discharged, the inkjet print head 20 may further include an idle pressure chamber 228 and an idle piezoelectric body 270. Here, the idle pressure chamber 228 is disposed outside the piezoelectric body 25 in the width direction and does not perform an ink discharge operation, and a membrane 227 is interposed between the idle pressure chamber 228 and the idle piezoelectric body 270 (see FIG. 3).

Here, the combination of the idle pressure chamber 228 and the idle piezoelectric body 270 is defined as an idle cell in comparison with a driving cell, which is the combination of the pressure chamber 224 and the piezoelectric body 250 driven in the inkjet print head 20.

FIG. 3 is a schematic cross-sectional view taken along the line III-III, illustrating the inkjet print head of FIG. 1.

Referring to FIG. 3, the section of the idle cell can be well understood.

As in the driving cell, the inkjet print head 20 of the idle cell may include an ink inlet 226, a reservoir 248, a pressure chamber 228, a restrictor 245, a damper 243, and a nozzle, and thus forms an ink passage.

Those components of the idle cell may have the same functions as the internal components of the inkjet print head 20 described with reference to FIG. 2, except that they do not take part in the ink discharge to the outside.

Like the piezoelectric body 250 of FIG. 2, the idle piezoelectric body 270 is also provided with upper and lower electrodes. As the measuring unit 40 is connected to these upper and lower electrodes, the capacitance of the idle piezoelectric body 270 can be measured.

The capacitance of the idle piezoelectric body 270 and the capacitance of the piezoelectric body 250 of FIG. 2 can be measured independently or concurrently.

FIG. 4 is a graph illustrating relations among temperature, capacitance and change rates for explaining a method of measuring a temperature of an inkjet print head according to an exemplary embodiment of the present invention.

A temperature change can be measured according to the change rate of capacitance (hereinafter, capacitance change rate) by using the piezoelectric body 250 or the idle piezoelectric body 270.

First, the capacitance of the piezoelectric body 250 or the idle piezoelectric body 270 is measured at an initial temperature to thereby determine an initial capacitance value. Subsequently, while the temperature is changed gradually, the capacitance of the piezoelectric body 250 or the idle piezoelectric body 270 is measured at each temperature and compared to the initial capacitance value to thereby obtain a difference value. Here, the capacitance change rate may be measured on the basis of the difference between the capacitance obtained at each temperature and the initial capacitance value.

It can be seen from FIG. 4 that, when capacitance is measured while varying the temperature of the inkjet print head 20 between 20° C. to 80° C., relations between the temperature and the capacitance and between the temperature and the capacitance change rate change linearly.

The horizontal axis of FIG. 4 represents the temperature of the piezoelectric body 250 or the idle piezoelectric body 270, and the vertical axes represent the measured capacitance (circular dots) of the piezoelectric body 250 or the idle piezoelectric body 270, and the capacitance change rates (diamond-shaped dots).

When an initial temperature is set to 27° C., which is a normal temperature, the capacitance value is 460 pF and a capacitance change rate is set to zero.

When the temperature is changed to 40° C., a capacitance value is 480 pF at 40° C., and the capacitance change rate is approximately 5%. When the temperature is continuously measured at temperature intervals of 10° C., the capacitance change rate increases linearly by approximately 5%.

Therefore, when the measured capacitance of the piezoelectric body 250 or the idle piezoelectric body 270 is 520 pF, the capacitance change rate (about 15%) between the initial capacitance value and the measured capacitance is measured to thereby determine a temperature, i.e. 60° C. accordingly.

As set forth above, according to an inkjet print head and a method of measuring a temperature thereof according to exemplary embodiments of the invention, the capacitance of a piezoelectric body affecting actual ink ejection is measured directly, and a temperature is measured on the basis of the measured capacitance, so that the temperature can be measured more accurately and quickly.

Furthermore, since a separate temperature measuring mechanism such as a thermocouple or a laser measuring device, is not used, the process of producing an inkjet print head or the temperature measuring method can be simplified.

While the present invention has been shown and described in connection with the exemplary embodiments, it will be apparent to those skilled in the art that modifications and variations can be made without departing from the spirit and scope of the invention as defined by the appended claims.

What is claimed is:

1. An inkjet print head comprising:
a plurality of pressure chambers receiving and storing ink which is to be discharged to a nozzle;
a piezoelectric body interposing a membrane with the pressure chamber, the piezoelectric body providing a driving force for discharging ink to each of the pressure chambers; and
a measuring unit measuring capacitance of the piezoelectric body so that a temperature of ink being discharged to the nozzle is measured.

2. The inkjet print head of claim 1, further comprising:
an idle pressure chamber configured to control a pressure of the ink being discharged, the idle pressure chamber not performing an ink discharge operation; and
an idle piezoelectric body interposing a membrane with the idle pressure chamber.

3. The inkjet print head of claim 2, further comprising a measuring unit measuring capacitance of the idle piezoelectric body.

4. An inkjet print head comprising:
a plurality of pressure chambers receiving and storing ink which is to be discharged to a nozzle;
a piezoelectric body interposing a membrane with the pressure chamber, the piezoelectric body providing a driving force for discharging ink to each of the pressure chambers;
an idle pressure chamber disposed outside the pressure chamber in a width direction to control a pressure of the ink being discharged, the idle pressure chamber not performing an ink discharge operation;
an idle piezoelectric body interposing a membrane with the idle pressure chamber; and
a measuring unit measuring capacitance of the idle piezoelectric body so that a temperature of the ink being discharged to the nozzle is measured.

5. A method of measuring a temperature of an inkjet print head, the method comprising:
setting an initial capacitance value by measuring capacitance of a piezoelectric body or an idle piezoelectric body at an initial temperature;
while varying a temperature, measuring capacitance of the piezoelectric body or the idle piezoelectric body at each varied temperature, and obtaining a difference value between the initial capacitance value and the measured capacitance to set a capacitance change rate; and
measuring a temperature, which is to be measured, by measuring capacitance of the piezoelectric body or the idle piezoelectric body and comparing a capacitance change rate of the measured capacitance with the set capacitance change rate.

6. The method of claim 5, wherein the initial temperature is set between 20° C. and 80° C., and the temperature is varied at constant intervals.
